(19) United States
(12) Patent Application Publication
(10) Pub. No.: US 2011/0173591 A1
(43) Pub. Date: Jul. 14, 2011

(54) Unit Test Generator

(75) Inventor: Girish Prasad, Bangalore (IN)

(73) Assignee: TARGET BRANDS, INC., Minneapolis, MN (US)

(21) Appl. No.: 12/686,955

(22) Filed: Jan. 13, 2010

(51) Int. Cl. G06F 9/44

(52) U.S. Cl. 717/126

(57) ABSTRACT

In one example, a software unit test generator is configured to receive a design document and a software unit. In this example, the design document includes a table of business objects in an enterprise software system and business rules that define the behavior of the business objects and the software unit includes a business rules engine that controls the behavior of the business objects. Continuing this example, a software unit test generator analyzes a design document to extract some or all of the business rules, and the software unit test generator creates a plurality of test scripts that, when executed, verify that a software unit conforms to the business rules. In some implementations, parameters for the test scripts are determined from the design document. In this example, a software unit test generator executes a collection of test scripts on the software unit and collects the results of the test scripts.

### BACKGROUND

Software development presents complex engineering challenges. Developers, development resources, time, money, and business requirements are all managed to meet deadlines, budgets, and other constraints. Organizing communication and workflow between developers becomes important as more developers contribute to a software development project.

The software development cycle is often defined by a series of milestones. These milestones can break a large project into smaller units for the purposes of organization, management, testing, and measurement. A milestone can be defined in terms of functional requirements, a list of tests to be completed, or in other terms. A subsection of the final software result, called a unit, can be developed to meet the requirements of the milestone.

Software can be tested during many stages of the software development process. Software testing can be used to verify that software works in an expected way and to verify that software fills the original need or goal of the development project. Software can be tested using formalized tests, ad hoc testing, or a combination of both.

Design documents can be used to define software that is being developed. Design documents are created by engineers, business analysts, artists, or other actors in a software development project to communicate ideas with other actors. Design documents can describe functionality, structure, appearance, behavior, or other aspects of the software.

### SUMMARY

In one example, a software unit test generator is configured to receive a design document and a software unit. In this example, the design document includes a table of business objects in an enterprise software system and business rules that define the behavior of the business objects and the software unit includes a business rules engine that controls the behavior of the business objects. Continuing this example, a software unit test generator analyzes a design document to extract some or all of the business rules, and the software unit test generator creates a plurality of test scripts that, when executed, verify that a software unit conforms to the business rules. In some implementations, parameters for the test scripts are determined from the design document. In this example, a software unit test generator executes a collection of test scripts on the software unit and collects the results of the test scripts. The results of the test scripts may be compiled into a report that includes tests that pass, tests that fail, and reasons for the failed tests. In some embodiments, the report is displayed through a graphic user interface or stored to disk.

The details of one or more implementations are set forth in the accompanying drawing and description below. Other features, objects, and advantages will be apparent from the description and drawings, and from the claims.

### DESCRIPTION OF DRAWINGS

FIG. 1 shows an example testing system for unit testing software.

FIG. 2 shows an example computer system for performing software tests.

FIG. 3 is a swim lane diagram showing an example process for testing software.

FIG. 4 shows an example human readable design document for describing behavior of software objects.

FIG. 5 shows an example report containing the results of a unit test.

FIG. 6 is a block diagram of a computing system optionally used in connection with computer-implemented methods described in this document.

Like reference symbols in various drawing indicate like elements.

### DETAILED DESCRIPTION OF ILLUSTRATIVE IMPLEMENTATIONS

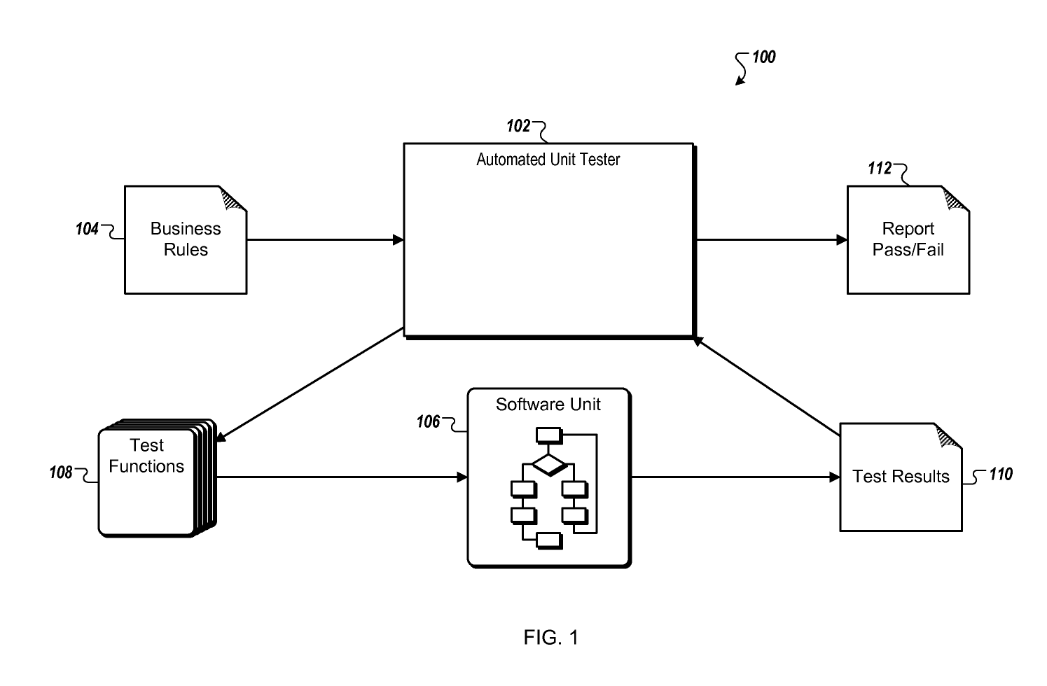

FIG. 1 shows an example testing system 100 for unit testing software. The testing system 100 includes an automated unit tester 102 that receives a business rules document 104 and a software unit 106. The automated unit tester 102 tests the software unit 106 to determine if the software unit 106 correctly implements the rules in the business rules document 104. The automated unit tester 102 is to ensure that the software unit 106 is correctly developed and is a reliable component in a software application.

The business rules document 104 contains one or more rules that describe the behavior of the software unit 106. In one implementation, the rules in the business rules document 104 define relationships between input received by the software unit 106 and output generated by the software unit 106. For example, the software unit 106 receives business objects such as new transaction requests, employee change requests, and stock adjustments. The rules in the business rules document 104 define response messages that should be created by the software unit 106 in response to new transaction requests, employee change requests, and stock adjustments.

The rules in the business rules document 104 are stored and displayed in a human readable format such as text instructions, fuzzy logic, and/or lists of categories with numeric data.

The automated unit tester 102 examines the business rules document 104 to determine the business rules contained therein. The automated unit tester 102 creates one or more test functions 108 that, when executed, cause the software unit 106 to create test results 110 that are examined to determine if the software unit 106 executes in accordance with the business rules. Based on the test results 110, the unit test generator 122 prepares a report detailing the test functions 108 that have passed and failed.

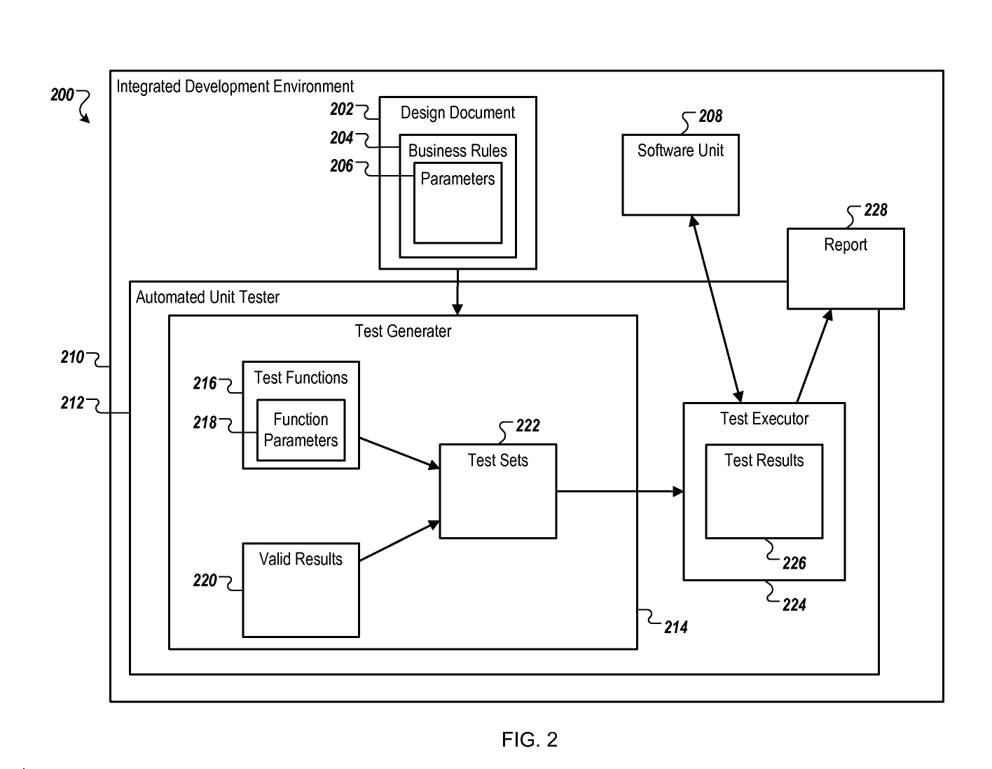

FIG. 2 shows an example computer system 200 for performing software tests. The system tests a software unit 208 to determine if the software unit 208 complies with a design document 202. The software unit 208 is a software application or part of a software application, for example, for use in an enterprise software application. In some implementations, the computer system 200 is used for testing processes in a test driven software development process.

The design document 202 is a design document, for example, created by a software developer, business analyst, or other persons. The design document 202 contains business rules 204 and parameters 206 that define interactions and/or behaviors of objects in an enterprise software application. In some implementations, the business rules 204 include fuzzy logic, Boolean operations, response events, propositional calculus formula, and/or other methods of describing behavior. The business rules 204 include parameters for defining the business rules. For example, a business rule may apply to a business object with a variable set to one value and not apply to the same business object with the same variable set to another value.

The software unit 208 is an untested software unit designed to implement the business rules 204. In some implementations, errors in planning, implementation, and utilization, for example, introduce errors into the software unit 208.

The software unit 208 is developed in an integrated development environment (IDE) 210. The IDE 210 includes software development tools such as code editors, version trackers, debuggers, and/or an automated unit tester 212. The automated unit tester 212 receives the design document 202 and the software unit 208 and tests the software unit 208 to determine if the software unit 208 correctly implements the business rules 204.

The automated unit tester 212 examines, parses, or otherwise reads the design document 202 to identify the business rules 204 and the parameters 206. The test generator 214 creates test functions 216, function parameters 218, and valid results 220 based on the business rules 204 and the parameters 206. The test generator 214 creates test sets 222 that contain a test function 216, one or more of the valid results 220, and optionally contain one or more function parameters 218. The valid results 220 in a test set 222 represent the result of expected behavior of the software unit 208 in light of the business rules 204 when receiving an event simulated or created by execution of the test function 216 with any optional parameters in the test sets 222. In some implementations, a plurality of test sets 222 contain different function parameters 218 and the same test function 216 or copies of the same test function 216. In some of these implementations, a business rule is tested under different circumstances or situations. In some implementations, a plurality of the test sets 222 contain different test functions 216 and the same function parameters 218 or copies of the same function parameters 218. In some of these implementations, multiple business rules are tested on the same circumstance or situation, for example, to discover unexpected side effects or interactions. In some implementations, the test generator 214 creates one or more test sets 222 for each business rule 204, ensuring that each business rule is tested.

The test generator 214 passes the test sets 222 to a test executor 224. The test executor evaluates the test sets 222 by executing the test functions 216 contained in the test sets 222. The test functions 216 create a message that is sent to the software unit 208. The software unit 208 generates a response and returns the response to the test executor 224. In some implementations, an ‘empty’ or ‘null’ response from the software unit 208 is assumed if no response is received by the test executor 224 within a certain time window after sending a message to the software unit 208.

In some implementations, repeat or logically redundant test sets 222 are identified by the test executor 224, and all but one of the redundant test sets 222 are deleted or ignored.

The test executor 224 creates test results 226 by comparing the response messages to the valid results 220 to determine if the software unit 208 executes in compliance with the business rules 204. In some implementations, the response message and the valid results 220 are equivalent or contain identical data, but are in different formats. In these implementations, the response message and/or the valid results 220 are transformed or reformatted as part of the comparison performed by the test executor 234.

The test executor 224 generates a report 228 that lists the test results 226. In some implementations, the report 228 that includes failure indications also includes additional information such as reasons for the failure indication and/or the test function 216, the valid result 220, and any of the optional function parameters 218 associated with the failure. The IDE 210 displays the report 228 on a computer display, saves the report 228 to a computer readable medium and/or prints the report 228 to paper.

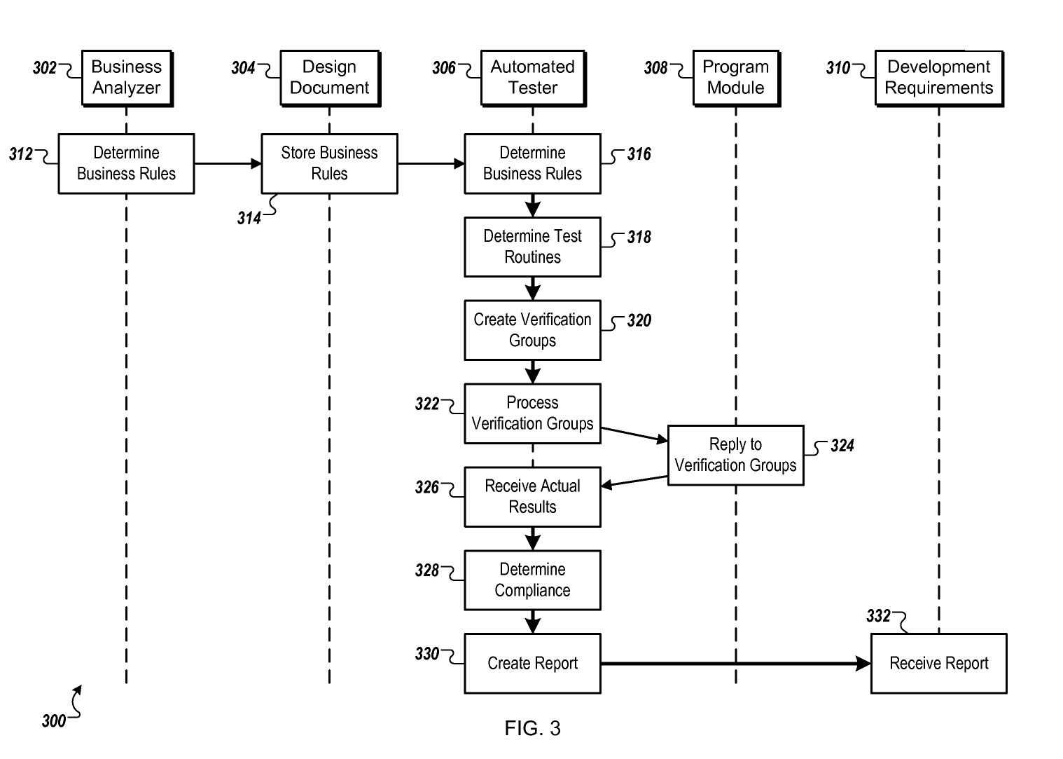

FIG. 3 is a swim lane diagram showing an example process 300 for testing software. The process 300 is used to determine if a program module 308 executes according to the needs of a set of rules determined by a business analyzer 302 and used to create a report describing the program module's 308 execution.

The business analyzer 302 is a software application that examines the workflow of an enterprise system, such as a business or government. A design document 304 is a document that describes the behavior of the program module 308 in a specific and formalized format suitable for examination by human users or other software applications. An automated tester 306 is a software application that tests the program module 308 to determine if the program module 308 executes in accordance with the specification of the design document 304. Development requirements 310 is a software application that records the status of the program module 308, including information relating to the program module's 308 compliance with the design document 304.

The business analyzer 302 determines business rules 312. In this implementation, the business analyzer 302 receives information related to environmental usage laws and determines a set of business rules 312 to prevent illegal actions in regard to the environmental usage laws.

The design document 304 receives and stores the business rules 314. In this implementation, the design document is created by the business analyzer 302, optionally examined and edited by a human user, and saved to a computer readable medium.

The automated tester 306 receives and determines the business rules 316. In this implementation, the automated tester 306 accesses and reads the computer readable medium that stores the design document 304.

The automated tester 306 determines a set of test routines 318 based on the business rules. In this implementation, the test routines generate a message representing a proposed environmental usage that, when received by the program module 308, should cause the program module 308 to generate and send a reply message.

The automated tester 306 creates verification groups 320. In this implementation, the automated tester 306 creates expected replies and pairs the expected replies with test routines. The expected reply is either an authorization reply or a denial reply, signifying permission or denial of the proposed environmental usage.

The automated tester 306 processes the verification groups 322. In this implementation, the automated tester 306 executes the test routines and transmits the resulting messages to the program module 308.

The program module 308 receives the message from the automated tester 306 and replies to the verification groups 324 in the automated tester 306. In this implementation, the program module 308 examines the message, determines if the proposed environmental usage will be allowed, and replies with an authorization reply, a denial reply, or a suggested alternative reply.

The automated tester 306 receives the actual results 326 from the program module 308 and determines the program module's 308 compliance 328. In this implementation a suggested alternative reply is changed to a denial, as a suggested alternative reply is a special case of a denial in which an authorized alternative is detected by the program module 308. The actual results are compared with the expected results. Verification groups that contain a denial expected result and receive an authorization actual result, or that contain an authorization expected result and receive a denial actual result, are labeled as an error. All other verification groups are labeled as correct.

The automated tester 306 creates a report 330 describing the program module's 308 compliance 328. In this implementation the report is a hypertext markup language document (HTML) containing a list of all error verification groups and a list of all correct verification groups. The display of each verification group includes an embedded link to a HTML page that gives full details of the verification group and actual result.

The development requirements 310 receives the report 322. In this implementation the development requirements 310 is an intranet web page maintained by the organization developing the program module 308 that displays the reports in a web browser.

In an alternative implementation, the program module 308 performs a complex, non deterministic calculation that returns one of multiple correct results. For example the program module 308 is a cellular telephone application that determines a good restaurant to go to based on location, time, user preferences and other factors. In this implementation, the business analyzer 302 determines business rules 312 about a city's restaurant environment. The automated tester 306 creates verification groups 320 that contain multiple expected results. The automated tester 306 determines compliance 328 by measuring the difference between actual results from the program module 308 and the most similar expected result. For example, an Italian restaurant open till midnight with a price rating of “$$” is more similar to an Italian restaurant and bar open till 2:00 am with a price rating of “$$” than to a Mongolian grill open till midnight with a price rating of “$$$$.” The automated tester 306 creates a report listing the verification groups 320 in order of greatest distance between expected results and actual results. In this implementation, the development requirements 310 determines from the report an acceptable difference and highlight verification groups with a greater difference.

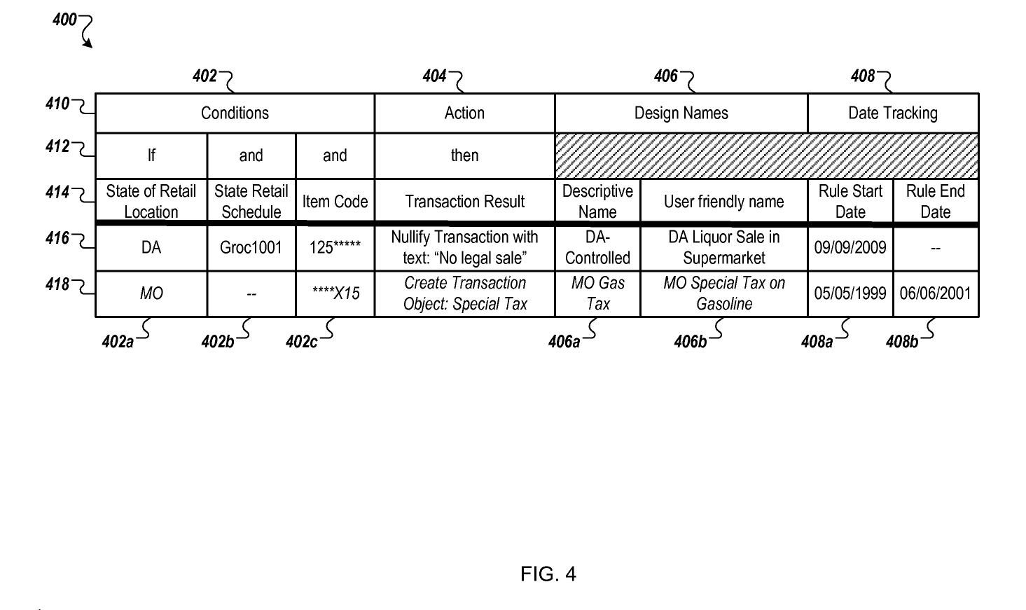

FIG. 4 shows an example human readable design document 400 for describing behavior of software objects. The human readable design document 400 is a spread sheet that contains rules related to the behavior of a system that receives business objects as input and creates business objects in response.

In one implementation, the human readable design document 400 contains header rows 410-414 and rule rows 416 and 418. Business rules are defined in the rule rows 416 and 418. The header row 410 describes broad categories for data in the rule rows 416 and 418. The header row 412 describes logical functions used in reading data in the rule rows 416 and 418. The specification row 414 describes the specific type of data in the rule rows 416 and 418.

A conditions column 402 contains logical functions that describe when a data row applies. The conditions column 402 contains up to three conditional sub-columns 402a-402c. Logical operators for the conditional sub-columns 402a-402c are shown in the header row 412. Example logical operators include “if,” “and,” “or,” “xor,” and “not.”

An action column 404 contains listings that describe actions in a data row. Actions described are related to conditions listed in the conditions column 402 in the same row. In some implementations, a fuzzy logic system is created by pairing actions listed in the action column 404 and the conditions column 402.

A design names column 406 lists names for rule rows. A column 406a lists descriptive names that are useful for, for example, compiling technical reports, creating large lists of information, or other uses. A column 406b lists user friendly names that are useful for, for example, verbally conversing about a rule row.

A date tracking column 408 lists a date that a rule row is active. A start date column 408a lists a beginning date and an end date column 408b lists an ending date. In some implementations, the presentation of rule rows listing an inactive date is optionally modified, such as by italicizing text, changing color, and/or other methods.

When a system designed to implement the human readable design document 400 detects an event that satisfies a row of the conditions column, that row is applicable to the event. The system, in response to the event, should perform the action listed in the action column 404 if the event occurred during the time listed in the date tracking column 408.

In one example, an event to request a liquor sale transaction has a state retail location of “DA” (indicating the request comes from a state abbreviated by DA), a state retail schedule of “Groc1001” (indicating the request comes from a grocery store), an item code that starts with “125” (indicating the item to sell is liquor), and a date of Oct. 10, 2009. In this example, the rule row 416 applies to this event. In the DA state, laws prevent the sale of liquor in a grocery store, so an action to nullify the transaction is listed in the action column 404.

In another example, an event to sell gasoline has a state retail location of “MO” (indicating the request comes from a state abbreviated by MO), an item code that ends with “X15 (indicating the item to sell is gasoline), and a date of Oct. 10, 2009. In this example, the rule row 418 does not apply to this event, because the date of the event is outside of the date range listed in the date tracking column 408.

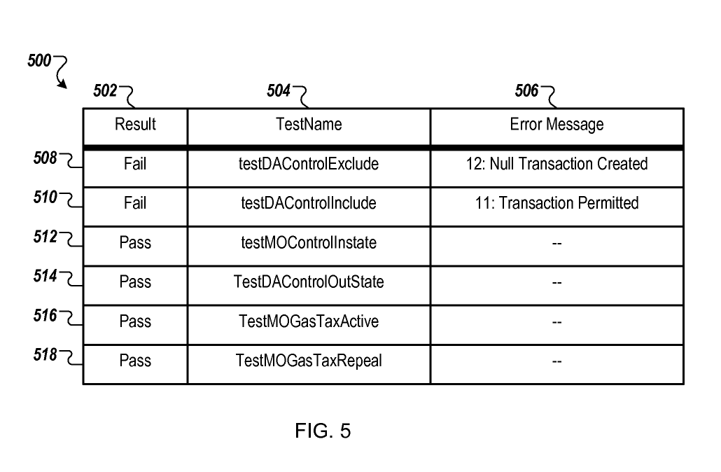

FIG. 5 shows an example report 500 containing the results of a unit test. The report 500 shows the results of a series of test routines, which either pass or fail, and an error message for test routines that fail.

A result column 502 lists results, either pass or fail, for each test. A test name column 504 lists the name of each test performed. An error message column 506 lists an error message that describes the way or reason that a test failed. Results of tests are listed in the rows 508-518. In some implementations, the rows 508-518 are optionally sorted based on the contents of a column in each row.

In some implementations, additional and/or alternative results are optionally listed in the result column 502. For example, some tests are nondeterministic or probabilistic. In these cases, a percentage, color, or other indication is listed.

In some implementations, the name listed in the test name column 504 includes codes or formats that describe aspects of the test that is named. For example, the test names testDAControlExclude, testDAControlInclude, testMOControlInstate begin with the word “test” and then a two letter state abbreviation (either “DA” or “MO”). In this implementation, the state abbreviation signals the state value used in the test.

In some implementations, the error messages listed in the error message column 506 include a text description and code of an error or reason that a test failed. The text description lists a brief synopsis of the error message and the code references a more complete error message, for example, in another document.

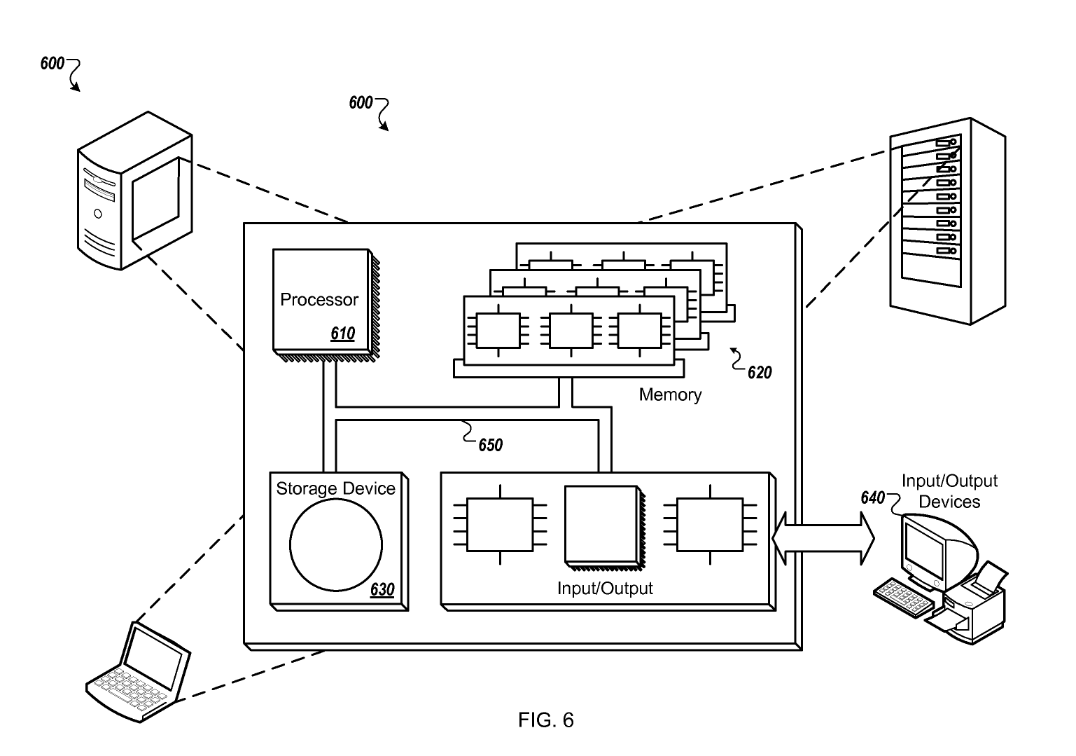

FIG. 6 is a block diagram of a computing system optionally used in connection with computer-implemented methods described in this document.

FIG. 6 is a schematic diagram of a generic computer system 600. The system 600 is optionally used for the operations described in association with any of the computer-implement methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 is optionally a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

In some examples, the features described are implemented in digital electronic circuitry, or in computer hardware, firmware, software, or in combinations of them. The apparatus is optionally implemented in a computer program product tangibly embodied in an information carrier, e.g., in a machine-readable storage device or in a propagated signal, for execution by a programmable processor; and method steps are performed by a programmable processor executing a program of instructions to perform functions of the described implementations by operating on input data and generating output. The described features are optionally implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that are optionally used, directly or indirectly, in a computer to perform a certain activity or bring about a certain result. A computer program is optionally written in any form of programming language, including compiled or interpreted languages, and it is deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory are optionally supplemented by, or incorporated in, ASICs (application-specific integrated circuits).

To provide for interaction with a user, the features in some instances are implemented on a computer having a display device such as a CRT (cathode ray tube) or LCD (liquid crystal display) monitor for displaying information to the user and a keyboard and a pointing device such as a mouse or a trackball by which the user provides input to the computer.

The features are optionally implemented in a computer system that includes a back-end component, such as a data server, or that includes a middleware component, such as an application server or an Internet server, or that includes a front-end component, such as a client computer having a graphical user interface or an Internet browser, or any combination of them. The components of the system are connected by any form or medium of digital data communication such as a communication network. Examples of communication networks include, e.g., a LAN, a WAN, and the computers and networks forming the Internet.

The computer system optionally includes clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications are optionally made without departing from the spirit and scope of this disclosure. Accordingly, other embodiments are within the scope of the following claims.

What is claimed is:

1. A system for generating and executing a software unit test, the system comprising:
a rules presentation module including a rule-set that comprises one or more software behavior rules wherein the rules presentation module presents the rule-set in a format readable by a human;
a software unit including at least a portion of a software application, wherein the software unit is to receive input and generate output in accordance with the rule-set;
a test generation module to create one or more test functions based on the rule-set, to create one or more expected outputs, and to create one or more test-sets, wherein each of the test-sets includes a test function and an expected output and wherein the rules presentation module presents the rule-set to the test generation module; and
a test execution module to receive the test-sets from the test generation module, to execute the test function of each of the test-sets, to receive output associated with one of the test-sets, to compare each of the test outputs to the expected output of the associated test-set in order to determine if the software unit correctly implements the rule-set, to create a report including a result of the comparison, and to send test input for each of the test-sets to the software unit.

2. The system of claim 1, wherein the test generation module creates one or more test parameters based on the rule set, wherein one or more of the test-sets contain one or more parameters, and wherein the execution of the test functions includes using the test parameters contained in the test-set that contains the test function.

3. The system of claim 1, wherein the one or more test-sets test each software behavior rule in each rule set.

4. The system of claim 1, wherein redundant test-sets are identified and eliminated.

5. The system of claim 1, wherein the rule-set defines behavior between objects in an enterprise software system.

6. The system of claim 1, wherein the software behavior rules are business rules.

7. The system of claim 1, wherein the rules presentation module comprises a spreadsheet.

8. The system of claim 1, wherein the report includes a list of failed test functions.

9. The system of claim 8, wherein the report includes a list of failure reasons associated with the list of failed test functions.

10. The system of claim 1, wherein the software unit is generated with an integrated development environment and wherein the integrated development environment includes the system.

11. The system of claim 1, wherein the software unit is generated in a test driven design development process, and wherein the system is used to perform tests in the test driven design development process.

12. A computer implemented method of performing an automated software test, the method comprising:
receiving, at an automated tester, a human readable design document comprising one or more execution rules and a program module to execute in compliance with the execution rules, wherein the program module is a software program or a module of a software program;
determining, by the automated tester, the execution rules associated with the design document, and creating one or more verification groups associated with an execution rule and containing a test routine and an expected result, wherein the test routine of each verification group, upon execution, creates a message and sends the message to the program module, wherein the message is defined by the execution rule associated with the verification group containing the test routine, and wherein the expected result of each verification group is defined by the execution rule associated with the verification group containing the expected result;
processing, by the automated tester, the verification groups by executing the test routines contained in the verification groups, wherein the processing includes receiving actual results from the program module, each of the actual results being associated with a verification group and further includes assigning to each of the verification groups a verification status determined by comparing the expected results of each of the verification groups to the actual results associated with the verification group; and
reporting, by the automated tester, the verification status of each of the verification groups.

13. The method of claim 12, wherein the human readable design document is a matrix comprising Boolean logic and response events.

14. The method of claim 12, wherein a plurality of the verification groups contain one of the test routines.

15. The method of claim 12, wherein comparing the expected results of each of the verification groups to the actual results associated with the verification group includes transforming one of the expected results and the actual results into a software object of equivalent value.

16. The method of claim 12, wherein the reporting includes displaying on a computer monitor.

17. A machine readable medium having recorded therein instructions that when executed perform a method for testing a software module, the method comprising:
receiving, at a software testing application, a requirement specification formatted for human reading comprising one or more specification rules;
receiving, at the software testing application, a software module designed to execute in compliance with the specification rules;
determining, by the software testing application, the specification rules from the requirement specification;
creating, by the software testing application, one or more test sets associated with an execution rule and containing a verification function associated with a verification group and a specified return, wherein the verification function of each verification group upon execution creates a message and sends the message to the software module, wherein the message is at least partially defined by the execution rule associated with the verification group containing the verification function, and wherein the specified return of each verification group is defined by the execution rule associated with the verification group containing the specified return;
processing, by the software testing application, the test sets by executing the verification functions contained in the test sets, wherein the processing includes receiving actual results from the software module, wherein each of the actual results is associated with a verification group, and wherein the processing includes assigning to each of the test sets a verification status determined by comparing the specified returns of each of the test sets to the actual results associated with the verification group; and
reporting, by the software testing application, the verification status of each of the test sets.

18. The method of claim 17, wherein the requirement specification formatted for human reading is a matrix comprising Boolean logic and response events.

19. The method of claim 17, wherein a plurality of the test sets contain one of the verification functions.

20. The method of claim 17, wherein comparing the specified returns of each of the test sets to the actual results associated with the verification group includes transforming one of the specified returns and the actual results into a software object of equivalent value.
